(19) United States
(12) Patent Application Publication
(10) Pub. No.: US 2018/0062193 A1
(43) Pub. Date: Mar. 1, 2018

(54) HIGH-PERFORMANCE MICROBIAL FUEL CELL BASED ON CARBON WITH THREE-DIMENSIONAL SIEVE TUBE STRUCTURE AS ANODE

(71) Applicants: Dongguan University of Technology, Guangdong Province (CN); City College of Dongguan University of Technology, Guangdong Province (CN)

(72) Inventors: Faliang CHENG, Guangdong Province (CN); Meiqiong CHEN, Guangdong Province (CN); Min ZHANG, Guangdong Province (CN); Jiajin LIN, Guangdong Province (CN); Yantong YAO, Guangdong Province (CN); Jiayuan CHEN, Guangdong Province (CN); Zhiming ZHANG, Guangdong Province (CN)

(73) Assignees: Dongguan University of Technology, Guangdong Province (CN); City College of Dongguan University of Technology, Guangdong Province (CN)

(21) Appl. No.: 15/404,201

(22) Filed: Jan. 12, 2017

(30) Foreign Application Priority Data
Aug. 26, 2016 (CN) 201610735599.2

(51) Int. Cl. H01M 8/16; H01M 8/00; H01M 4/86; H01M 4/96

(52) U.S. Cl. CPC H01M 8/16; H01M 8/002; H01M 2004/8684; H01M 4/96; H01M 4/8626

(57) ABSTRACT

The present invention discloses a high-performance microbial fuel cell based on carbon with three-dimensional sieve tube structure as anode, comprising an anode and an electrode, wherein the anode is a carbon with three-dimensional sieve tube structure, and the three-dimensional sieve tube structure is a pie-shaped three-dimensional sieve tube structure or an annular-shaped three-dimensional sieve tube structure. The carbon with three-dimensional sieve tube structure is obtained by the carbonization of cassava straws which are agricultural solid residues. The high-performance microbial fuel cell based on carbon with three-dimensional sieve tube structure as anode according to the present invention has the features such as simple preparation method, easy to be amplified, environment-friendly, high power density and so on.

### CROSS-REFERENCE TO RELATED APPLICATION

This application claims the priority benefit of China application serial no. 201610735599.2, filed on Aug. 26, 2016. The entirety of the above-mentioned patent application is hereby incorporated by reference herein and made a part of this specification.

### TECHNICAL FIELD

The present invention relates to the technical field of microbial fuel cell, and particularly, to a high-performance microbial fuel cell based on carbon with three-dimensional sieve tube structure as anode.

### BACKGROUND

With the development of society, factories and population increase rapidly, leading to the rapid increase of discharge of sanitary sewage and the increase of industrial wastewater. Serious pollution of water resource has seriously affected the people's living environment and health. The cost needed for traditional sewage treatment industry is high, and the covering area needed for traditional sewage treatment industry is large. In fact, organic wastewater contains a lot of energy. Great social and economic benefits will be brought if this part of the energy can be recycled. Microbial fuel cells are new devices using microorganisms (such as various bacteria) to catalyze the oxidation of organic matter in the sewage and converting chemical energy into electrical energy directly. The microbial fuel cells generate electrical energy when treating and purifying sewage purification, which is the technology that has important application prospects in the 21st century. However, one of the key problems constraining the large-scale application of microbial fuel cells is its relatively low output of power density and energy density, and expensive manufacturing cost.

The biocompatibility, specific surface area, electrical conductivity, chemical stability and other performances of the anode material which serves as a catalytic interface of microorganisms directly affect the adsorption growth of the microorganism on the anode, electron transfer capability of the microorganism, electrode impedance, and output power density of the cells, etc. Commonly used anode materials are carbon materials such as carbon paper, carbon felt, graphite rod, graphite sheet, carbon cloth, carbon foam, carbon brush, graphite foam and so on. This is mainly because that the carbon materials have good stability, excellent electrical conductivity and very good biocompatibility. The numerous carbon materials can be classified into one-dimensional, two-dimensional and three-dimensional carbon, wherein the three-dimensional carbon material, which is considered as a new generation of ideal anode material of microbial fuel cells, has a larger specific surface area and may accommodate more microorganisms and allow their attached growth.

At present, the exploited three-dimensional materials for microbial fuel cells are three-dimensional graphene-based electrode materials and other materials which are mainly constructed by methods such as chemical vapor deposition, electrodeposition, freeze drying and so on. Due to the reasons such as high conductivity and the porous structure for the growth of microorganisms, all these three-dimensional carbon-based materials used in microbial fuel cell anode can obtain a better power and energy density. However, the current ubiquitous problems are the high cost of graphene, the complicated apparatus used and difficulty of mass-production of the microbial fuel cells.

### SUMMARY OF THE INVENTION

The object of the present invention is to provide a high-performance microbial fuel cell based on carbon with three-dimensional sieve tube structure as anode. The present invention has the features such as simple preparation method, easy to be amplified, environment-friendly, high power density and so on.

The present invention can be realized by the following technical solutions:

The present invention discloses a high-performance microbial fuel cell based on carbon with three-dimensional sieve tube structure as anode, comprising an anode and an electrode, wherein the anode is a carbon with three-dimensional sieve tube structure, and the three-dimensional sieve tube structure is a pie-shaped three-dimensional sieve tube structure or an annular-shaped three-dimensional sieve tube structure.

In the present invention, the dual-chamber microbial fuel cell prepared by using carbon with three-dimensional sieve tube structure as anode has features of high output power density and high current density, and can obtain a stable output power density of 59.95 W/m³ (relative to the volume of the anode chamber) and a maximum current density of 173.11 A/m³. The power density and the maximum current density are 3.2 times and 4 times of those (18.48 W/m³ and 42.97 A/m³ respectively, relative to the volume of the anode chamber) of a microbial fuel cell using carbon paper as anode respectively. The three-dimensional sieve tube structure is a pie-shaped three-dimensional sieve tube structure or an annular-shaped three-dimensional sieve tube structure. The natural honeycomb-like porous sieve tube structure passing through two cross-sections can ensure the free entry and exit of microorganisms and the mass transfer function being proceeded smoothly, and thus the power density and current density of the cell are greatly increased.

Furthermore, the carbon with three-dimensional sieve tube structure is obtained by the carbonization of cassava straws which are agricultural solid residues. Its preparation process is simple and it is easy to be amplified. Its materials come from the recycle of biomass energy and the resource recovery of the solid waste, which has a very good social significance and economic value with respect to the multiple fields such as the environmental protection, the comprehensive utilization of pollutants, the waste recycling, the development of new energy and so on.

Furthermore, the carbon with three-dimensional sieve tube structure is prepared by the following method: using natural cassava straws as raw material, which are firstly calcined for 1.5 h in an anaerobic atmosphere at 150° C., and then carbonized for 1 h at 750° C., to obtain porous carbon materials with three-dimensional sieve tube structure.

Furthermore, the microbial fuel cell is a sandwich-type dual-chamber structure, comprising a cathode chamber, an anode chamber and a reactor disposed between the cathode chamber and the anode chamber.

Furthermore, the microbial fuel cell further comprises an anolyte prepared by following method: taking 10.0 g of sodium bicarbonate, 11.2 g of disodium hydrogen phosphate, 10.0 g of anhydrous glucose and 5 g of yeast extract, which are mixed and dissolved in a beaker, and then adding 0.8707 g of HNQ, and finally preserving the obtained solution into a 1000 mL volumetric flask and diluting to a constant volume after being stirred evenly.

Furthermore, the microbial fuel cell further comprises a catholyte containing 10.0 g/L of sodium bicarbonate, 11.2 g/L of disodium hydrogen phosphate and 50 mmol/L of K₃[Fe(CN)₆].

The present invention discloses a high-performance microbial fuel cell based on carbon with three-dimensional sieve tube structure as anode, which has the following advantages. The present invention provides a three-dimensional carbon with natural sieve tube structure which is prepared based on cassava straws, so as to develop and obtain a high-efficiency microbial fuel cell based on the three-dimensional anode. The present invention has the features such as simple preparation method, easy to be amplified, environment-friendly, high power density and so on. The present invention has far-reaching significance and good application prospects with respect to the fields such as the utilization and resource recovery of agricultural solid waste and, the waste water purification, the biomass energy recovery and the development of new energy and so on.

### DESCRIPTION OF FIGURES

FIGS. 1a and 1b show the scanning electron microscopy (SEM) views of carbon with three-dimensional sieve tube structure.

FIG. 2 shows the power density curve and polarization curve (calculated based on the volume of anode chamber) of a microbial fuel cell using carbon with a pie-shaped three-dimensional sieve tube structure as anode.

FIG. 3 shows the power density curve and polarization curve (calculated based on the volume of anode chamber) of a microbial fuel cell using carbon with an annular-shaped three-dimensional sieve tube structure as anode.

FIG. 4 shows the power density curve and polarization curve (calculated based on the volume of anode chamber) of a microbial fuel cell using commercial carbon paper as anode.

### DETAILED DESCRIPTION OF THE EMBODIMENTS

In order that the person skilled in the art may better understand the technical solution of the present invention, the present invention has been described in further detail below in combination with the embodiments and the accompanied drawings.

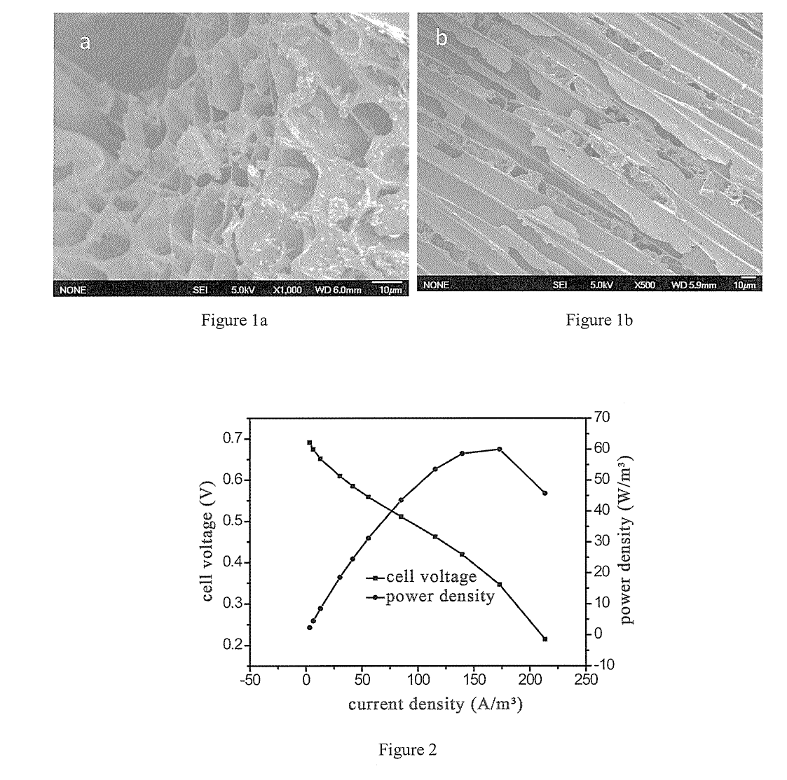

The present invention discloses a high-performance microbial fuel cell based on carbon with three-dimensional sieve tube structure as anode, comprising an anode and an electrode, wherein the anode is a carbon with three-dimensional sieve tube structure, and the three-dimensional sieve tube structure is a pie-shaped three-dimensional sieve tube structure or an annular-shaped three-dimensional sieve tube structure. The carbon with three-dimensional sieve tube structure is obtained by the carbonization of cassava straws which are agricultural solid residues. The carbon with three-dimensional sieve tube structure is prepared by the following method: using natural cassava straws as raw material, which are firstly calcined for 1.5 h in an anaerobic atmosphere at 150° C., and then carbonized for 1 h at 750° C., to obtain porous carbon materials with three-dimensional sieve tube structure. The SEM views of the finally obtained porous carbon materials with three-dimensional sieve tube structure are shown in FIGS. 1a and 1b.

FIG. 1a is a cross-sectional view and FIG. 1b is a profile. It can be clearly observed from the SEM views in FIGS. 1a and 1b that the carbonized cassava stalks have retained the original sieve tube structure. The diameter of these sieve tubes is about 20 microns, while the diameter of the common microorganisms is about 0.5×1˜3 microns, and thus these natural sieve tubes may allow the free entry and exit of microorganisms and allow the mass transfer to be proceeded smoothly.

Furthermore, the microbial fuel cell is a sandwich-type dual-chamber structure, comprising a cathode chamber, an anode chamber and a cation exchange membrane disposed between the cathode chamber and the anode chamber.

Furthermore, the microbial fuel cell further comprises an anolyte prepared by following method: taking 10.0 g of sodium bicarbonate, 11.2 g of disodium hydrogen phosphate, 10.0 g of anhydrous glucose and 5 g of yeast extract, which are mixed and dissolved in a beaker, then adding 0.8707 g of HNQ, and finally preserving the obtained solution into a 1000 mL volumetric flask and diluting to a constant volume after being stirred evenly.

Furthermore, the microbial fuel cell further comprises a catholyte containing 10.0 g/L of sodium bicarbonate, 11.2 g/L of disodium hydrogen phosphate and 50 mmol/L of K₃[Fe(CN)₆].

In order to further study the microbial fuel cell according to the present invention, the technical solutions of the present invention will now be further described in detail below in the embodiment 1 and embodiment 2 respectively.

### Embodiment 1

Embodiment 1 shows a microbial fuel cell using carbon with a pie-shaped three-dimensional sieve tube structure as anode. The specific method of its preparation, assembly and test is as follows:

Step 1: The preparation of the electrode material, eg. the carbon with a pie-shaped three-dimensional sieve tube structure.

The natural cassava straws are used as raw material, calcined for 1.5 h in an anaerobic atmosphere at 150° C. at first. and then carbonized for 1 h at 750° C., to obtain porous carbon materials with three-dimensional sieve tube structure.

Step 2: The preparation of anode and cathode.

Carbon column obtained in Step 1 is cut into a pie-shaped structure having a length of 2 cm, and then connected to the copper wire with the interface coated with epoxy resin as the anode. The cathode uses commercial carbon paper having an area of 2 cm*2 cm.

Step 3: The assembly, operation and test of microbial fuel cell.

The anolyte: taking 10.0 g of sodium bicarbonate, 11.2 g of disodium hydrogen phosphate, 10.0 g of anhydrous glucose and 5 g of yeast extract, which are mixed and dissolved in a beaker, and then adding 0.8707 g of HNQ, and finally preserving the obtained solution into a 1000 mL volumetric flask and diluting to a constant volume after being stirred evenly.

The catholyte: containing 10.0 g/L of sodium bicarbonate, 11.2 g/L of disodium hydrogen phosphate and 50 mmol/L of K₃[Fe(CN)₆].

The dual-chamber microbial fuel cell uses a sandwich-type dual-chamber structure, in which both the cathode chamber and the anode chamber have a volume of 20 mL.

The start-up of the cell and the measurement of power density curve and of polarization curve are as follows: 18 mL of anolyte is put into the reactor into which high-purity nitrogen is filled for 15 minutes. After the filling of the gas has been terminated, 2 mL of culture medium for E. coli is put into the reactor. The opening in the upper end of the reactor is blocked by a rubber plug such that the reactor is in a sealed condition. When the open-circuit voltage of the cell is stabilized, the cell is loaded with different resistances in sequence. The system automatically records the voltage, power density and current density of the cell loaded with different load resistances. Specific results of the measurement are shown in FIG. 2.

### Embodiment 2

Embodiment 2 shows a microbial fuel cell using carbon with an annular-shaped three-dimensional sieve tube structure as anode. The specific method of its preparation, assembly and test is as follows:

Step 1: The preparation of the electrode material, eg. the carbon with an annular-shaped three-dimensional sieve tube structure, is the same as that in Embodiment 1.

Step 2: The preparation of anode and cathode.

Carbon column obtained in Step 1 is cut into an annular-shaped structure having a length of 2 cm, and a relatively loose core of the carbon column is removed to obtain a carbon with an annular-shaped three-dimensional sieve tube structure. Then the carbon column is connected to the copper wire with the interface coated with epoxy resin as anode.

The preparation of the cathode is the same as that in Embodiment 1.

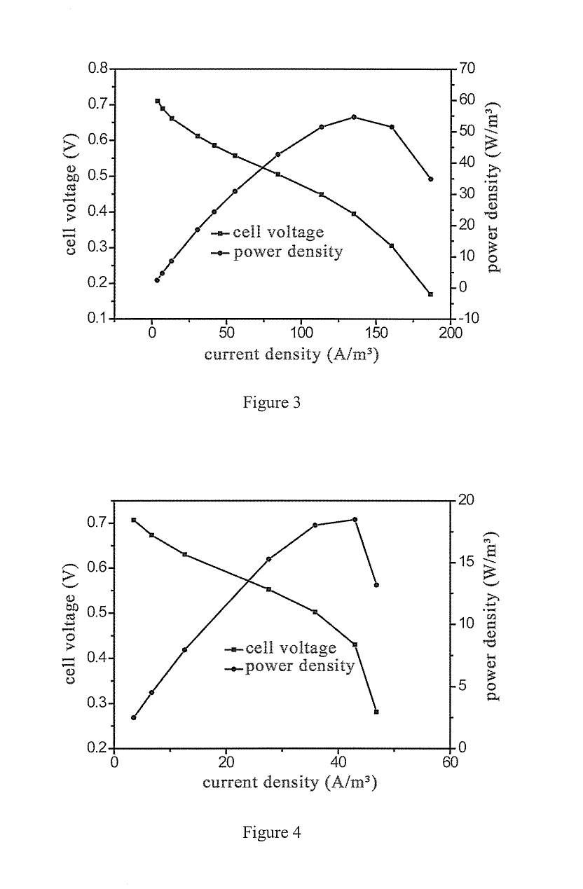

Step 3: The assembly, operation and testing of microbial fuel cell are the same as that in Embodiment 1. Specific test results are shown in FIG. 3.

Meanwhile, comparative Embodiment 1 is prepared by using commercial carbon paper as anode in order to evaluate the difference between the microbial fuel cell of the present invention and the prior art.

### Comparative Embodiment 1

The preparation method and the test method of microbial fuel cell using commercial carbon paper as anode are as follows.

Step 1: The preparation of anode: using commercial carbon paper having an area of 2 cm*2 cm.

Step 2: The preparation of cathode: the same as that in embodiment 1.

Step 3: The assembly, operation and testing of microbial fuel cell: the same as that in embodiment 1. Specific test results are shown in FIG. 4.

As can be seen from FIG. 2, the dual-chamber microbial fuel cell assembled and obtained by using carbon with a pie-shaped three-dimensional structure as anode can achieve a stable output power density of 59.95 W/m³ (relative to the volume of anode chamber) and a maximum current density of 173.11 A/m³, and the output power density and current density are 3.2 times and 4 times of those (18.48 W/m³ and 42.97 A/m³ respectively, as show in FIG. 4) of the microbial fuel cell using commercial carbon paper as anode.

As can be seen from FIG. 3, the dual-chamber microbial fuel cell assembled and obtained by using carbon with annular-shaped three-dimensional structure as anode can also achieve a stable output power density of 54.60 W/m³ (relative to the volume of the anode chamber) and a maximum current density of 134.92 A/m³, and the output power density and the current density are 2.95 times and 3.14 times of those (18.48 W/m³ and 42.97 A/m³ respectively, as show in FIG. 4) of the microbial fuel cell using carbon paper as anode.

The present invention provides a carbon with natural three-dimensional sieve tube structure which is prepared based on cassava straws, so as to develop and obtain a high-efficiency microbial fuel cell based on the three-dimensional anode. The present invention has the features such as simple preparation method, easy to be amplified, environment-friendly, high power density and so on. The present invention has far-reaching significance and good application prospects with respect to the fields such as the utilization and resource recovery of agricultural solid waste and, the waste water purification, the biomass energy recovery and the development of new energy and so on.

The above are the preferred embodiments of the present invention, and are not to be construed as limitation to the invention in any way. A person skilled in the art could implement the invention smoothly according to the descriptions above and the accompanied drawings. However, equivalent changes such as alteration, modification and evolution that are made based on the technical content revealed above, without departing from the spirit of the invention, are all equivalent embodiments of the present invention. In the meantime, all equivalent changes such as alteration, modification and evolution that are made according to substantive technology of the present invention should also fall within the protecting scope of the present invention.

What is claimed is:

1. A high-performance microbial fuel cell based on carbon with three-dimensional sieve tube structure as anode, comprising:
an anode, wherein the anode is a carbon with three-dimensional sieve tube structure, and the three-dimensional sieve tube structure is a pie-shaped three-dimensional sieve tube structure or an annular-shaped three-dimensional sieve tube structure; and
an electrode.

2. The high-performance microbial fuel cell based on carbon with three-dimensional sieve tube structure as anode of claim 1, wherein the carbon with three-dimensional sieve tube structure is obtained by the carbonization of cassava straws which are agricultural solid residues.

3. The high-performance microbial fuel cell based on carbon with three-dimensional sieve tube structure as anode of claim 1, wherein the carbon with three-dimensional sieve tube structure is prepared by the following method: using natural cassava straws as raw material, which are firstly calcined for 1.5 h in an anaerobic atmosphere at 150° C., and then carbonized for 1 h at 750° C., to obtain porous carbon materials with three-dimensional sieve tube structure.

4. The high-performance microbial fuel cell based on carbon with three-dimensional sieve tube structure as anode of claim 3, wherein the microbial fuel cell is a sandwich-type dual-chamber structure, comprising:
a cathode chamber;
an anode chamber; and
a cation exchange membrane disposed between the cathode chamber and the anode chamber.

5. The high-performance microbial fuel cell based on carbon with three-dimensional sieve tube structure as anode of claim 4, wherein the microbial fuel cell further comprises an anolyte prepared by following method: taking 10.0 g of sodium bicarbonate, 11.2 g of disodium hydrogen phosphate, 10.0 g of anhydrous glucose and 5 g of yeast extract, which are mixed and dissolved in a beaker, then adding 0.8707 g of HNQ, and finally preserving the obtained solution into a 1000 mL volumetric flask and diluting to a constant volume after being stirred evenly.

6. The high-performance microbial fuel cell based on carbon with three-dimensional sieve tube structure as anode of claim 5, wherein the microbial fuel cell further comprises a catholyte containing sodium bicarbonate, disodium hydrogen phosphate, and K₃[Fe(CN)₆], a concentration of the sodium bicarbonate is 10.0 g/L, a concentration of the disodium hydrogen phosphate is 11.2 g/L, and a concentration of the K₃[Fe(CN)₆] is 50 mmol/L.

7. The high-performance microbial fuel cell based on carbon with three-dimensional sieve tube structure as anode of claim 2, wherein the carbon with three-dimensional sieve tube structure is prepared by the following method: using natural cassava straws as raw material, which are firstly calcined for 1.5 h in an anaerobic atmosphere at 150° C., and then carbonized for 1 h at 750° C., to obtain porous carbon materials with three-dimensional sieve tube structure.

8. The high-performance microbial fuel cell based on carbon with three-dimensional sieve tube structure as anode of claim 7, wherein the microbial fuel cell is a sandwich-type dual-chamber structure, comprising:
a cathode chamber;
an anode chamber; and
a cation exchange membrane disposed between the cathode chamber and the anode chamber.

9. The high-performance microbial fuel cell based on carbon with three-dimensional sieve tube structure as anode of claim 8, wherein the microbial fuel cell further comprises an anolyte prepared by following method: taking 10.0 g of sodium bicarbonate, 11.2 g of disodium hydrogen phosphate, 10.0 g of anhydrous glucose and 5 g of yeast extract, which are mixed and dissolved in a beaker, then adding 0.8707 g of HNQ, and finally preserving the obtained solution into a 1000 mL volumetric flask and diluting to a constant volume after being stirred evenly.

10. The high-performance microbial fuel cell based on carbon with three-dimensional sieve tube structure as anode of claim 9, wherein the microbial fuel cell further comprises a catholyte containing sodium bicarbonate, disodium hydrogen phosphate, and K₃[Fe(CN)₆], a concentration of the sodium bicarbonate is 10.0 g/L, a concentration of the disodium hydrogen phosphate is 11.2 g/L, and a concentration of the K₃[Fe(CN)₆] is 50 mmol/L.
